(19) United States
(12) Patent Application Publication
(10) Pub. No.: US 2006/0150386 A1
(43) Pub. Date: Jul. 13, 2006

(54) Razor comprising a skeletal body and a bladder for a shaving agent, and a method for the manufacture thereof

(76) Inventors: Mahran Wanli, Bonn (DE); Giuseppe Susino, Koln (DE)

Correspondence Address: NILS H. LJUNGMAN;NILS H. LJUNGMAN & ASSOCIATES, P.O. BOX 130, GREENSBURG, PA, 15601-0130, US

(21) Appl. No.: 11/298,559

(22) Filed: Dec. 9, 2005

(30) Foreign Application Priority Data
Dec. 10, 2004 (DE) 10 2004 059 517.8

(51) Int. Cl. B23P 11/02; B26B 21/52

(52) U.S. Cl. 29/449; 30/526; 29/448

(57) ABSTRACT

A razor comprising a skeletal body and a reservoir for a shaving agent, and a method for the manufacture thereof. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to a new razor comprising a grip and a shaving appliance as well as a method for its manufacture.

2. Background Information

The known patent DE10117766A1 relates to a razor with a shaving appliance which includes an additional dispensing appliance for a shaving agent, in particular for a shaving gel, whereby the dispensing appliance is locally separated from the shaving appliance but is parallel to the shaving head basically across the entire length of the shaving head.

The known shaving appliance has a solidly built grip, in which the shaving agent is stored in a storage container. The storage container is emptied by a drive unit which is actuated either manually or by means of an electric motor.

The known appliance is costly in production and complicated in handling as the dispensing appliance for the shaving foam interferes with the shaving process. Moreover, due to the higher weight, the known razor is only suitable for certain parts of the skin, but not for a general shave.

### OBJECT OR OBJECTS

The objective is to develop a new razor and a process for its manufacture, with which all parts of the face can be reached well and a wet shave can be carried out economically by using a shaving agent stored in a container.

### SUMMARY

In keeping with the embodiments this objective is achieved by the characteristics rendered in the present application.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows a frontal view of a razor according to one possible embodiment;

FIG. 1A shows a skeletal razor handle according to one possible embodiment;

FIG. 1B shows a skeletal razor handle according to another possible embodiment;

FIG. 2 shows a side view of a razor according to one possible embodiment;

FIG. 3 shows a perspective view of a razor according to one possible embodiment;

FIG. 4 shows a perspective view of a razor according to one possible embodiment;

FIG. 5 shows a perspective view of a razor according to one possible embodiment;

FIG. 6 shows a bladder for holding shaving agents according to one possible embodiment; and

FIG. 7 shows a bladder for holding shaving agents according to one possible embodiment.

### DESCRIPTION OF EMBODIMENT OR EMBODIMENTS

A shaving gel is preferably used as a shaving agent, which is passed to the surface of the grip 2 through a nozzle opening 6R by deforming the elastic walls 7, 8, and from there it is distributed across the face surface by hand. The nozzle opening may comprise a simple hole or a valve opening. In the first case the elasticity of the grip is designed in such a way that prior to the first use a thin skin is fixed over the opening 6R which tears and completely frees the opening when pressed.

The present application teaches the construction of the hollow spaces used for the shaving agent and the after-shave agent. The hollow spaces shall be used to define a certain volume which is sealed off against the surrounding area. At a certain pre-defined point at least one opening is provided in the respective hollow space. The opening is self-sealing, which means that the shaving agent or the after-shave agent is passed to the surface only if a sufficiently high pressure is built up in the hollow space.

The pressure is built up mechanically by reducing the volume of the hollow space. For this purpose, either the lateral surfaces or the front side of the razor are elastic in the area of the respective hollow space. “Elastic” shall mean that the respective outside surface can be pressed inside by finger pressure so much that the volume of the hollow space is reduced by between ten and ninety percent.

According to one possible embodiment, the first intention is to construct the razor as a disposable product, which means that the hollow spaces are filled once only. Thus, after deformation of the corresponding pressure surface no spring-back into the initial condition is required as a rule.

However, each opening of the hollow space can be fitted with a two-sided active valve. In outlet direction, the valve would have the effect that the opening is opened up only as from a certain pressure. In inlet direction, the valve would ensure a gas exchange in order to return the hollow space into its original shape.

According to the present application, the production of the razor starts at the head part of the razor as usual. Only the grip will be designed as a plastic part with a new configuration. In its simplest case, the grip is produced as a single part with a single hollow space or a hollow space separated into two parts. The synthetic materials suitable for production are flexible thermoplastics, PE, PVC, PA as well as combinations thereof.

At least two different production methods are conceivable: In the first casting process, the razor is produced as an injection-moulded part with disposable cores. The disposable cores form the hollow spaces, into which resilient elastic pressure surfaces are integrated either on both parts of the narrow sides or on the front side.

In the second casting process, the razor is produced in skeleton construction whereby a flexible outside skin made of synthetic material is drawn over a carrying skeleton, in which the shaving agent and the after-shave agent are placed in ready-made bags. The openings comprise plastic nozzles which are screwed into the outside skin, and which penetrate the bags with their pointed ends.

The grip of the razor is constructed as a hollow body, and at its broadest part it is provided with a clampable or screwable closure.

After opening the closure, the shaving agent and the after-shave agent in their bags can be placed into the inside of the holder. By turning a pointed nozzle opening, the pointed nozzle penetrates the respective bag and produces a connection to the outside surface of the razor according to one possible embodiment. All other processes of actuation by means of the corresponding pressure surfaces of the grip are carried out as described above.

The intention of this new disposable razor is to permit a wet shave immediately without the use of any auxiliary means and without any preparation. Conventional razors, in particular razors for wet shaving, are fitted with a shaving facility, also referred to as shaving head, and with a grip. The shaving head holds the razor blades used for the shave. For a wet shave, a shaving agent is usually applied to the skin parts to be shaved. A shaving foam or a shaving gel or a foamed shaving gel, for example, is used to assist the shave by the shaving blade and thus to protect the skin parts to be shaved. The present application provides that a dispensing appliance in the form of two chambers is created in the grip of the razor to be used to store shaving agent and after-shave agent. For direct application of the shaving agent on to the part of the skin to be shaved, the surface of the respective space on the grip simply has to be pressed by hand so that the shaving agent or the after-shave agent flows through a hole on to the other hand. The razor blade holder, the shaving agent and the after-shave dispenser are combined in one unit, thus creating a wet shaver ideal for travelers, tourists, long-distance truck drivers, fitters, soldiers, et cetera.

In keeping with a special aspect of an embodiment, a space for the shaving agent and another space for the after-shave agent are preferred in the grip of the razor and the shaving agent and the after-shave agent are dispensed from the respective space. Advantageously, the shaving agent and the aftershave agent are stored and transported in the razor proper and need not be transported in a separate container.

The entire shaving head 3 along with the two razor blades can be removed from the grip 2 of the razor A and can be replaced.

As an alternative the razor blades in the shaving head may be removable and replaceable razor blades. In this case, the shaving head 3 is firmly mounted to the grip 2 by means of a joint bearing. In this case, only one replaceable razor blade shall be preferred.

The shaving agent 4R is dispensed from the storage compartment 4 through the hole 6R. Pressure is put on the shaving agent 4R in the storage compartment 4 so that the shaving agent 4R is pressed into the hand through the hole 6R. For generation of the pressure, one outer side of the grip 2 has been provided with an actuation surface RG which is arranged in such a way that it can be operated easily by a user of the razor prior to the shave.

The after-shave agent 5A is dispensed from the storage compartment 5 through the hole 6A. Pressure is put on the after-shave agent 5A in the storage compartment 5 so that the after-shave agent 5A is pressed into the hand through the hole 6A after the shave. For generation of the pressure, one outer side of the grip 2 has been provided with an actuation surface AS which is arranged in such a way that it can be operated easily by a user of the razor after the shave.

For this purpose, the grip 2 or the storage compartment 4, respectively, may be manufactured from any suitable material which has sufficient flexibility.

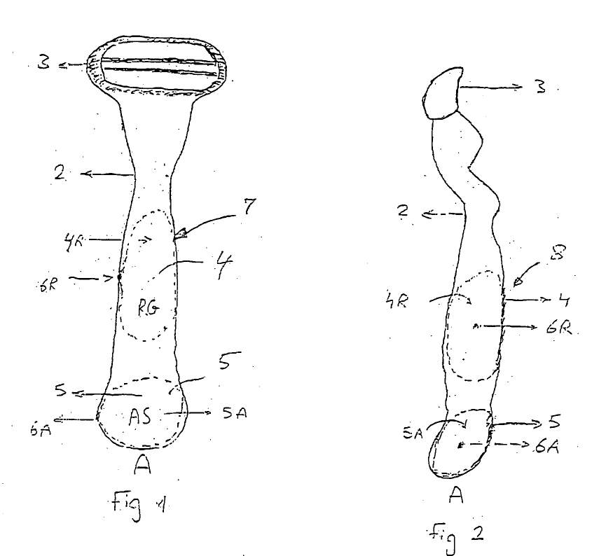

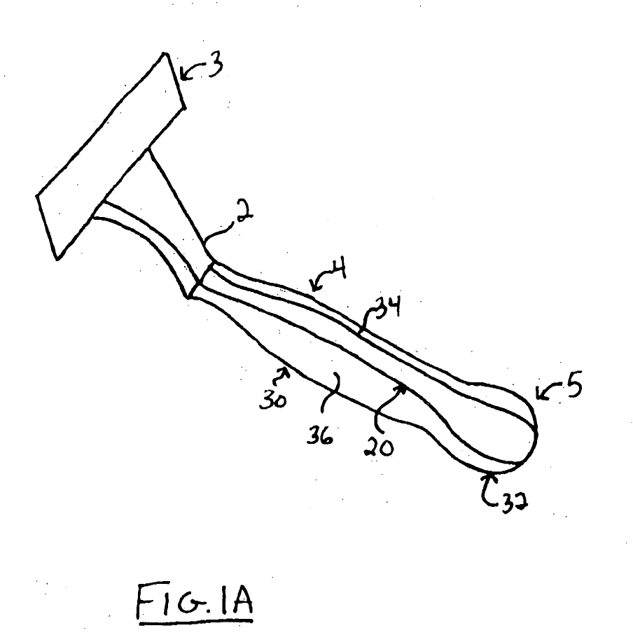

According to one possible embodiment, as shown in FIG. 1A, the razor 50 comprises a shaving head 3, a neck portion 2, an elongated body portion 30, and a bottom portion 32. The body portion 50 comprises a skeletal structure with skeletal rib portions 20, which rib portions 20 run from the neck portion 2 to the bottom portion 32. The hollow space 4 for a bladder 10 for holding a shaving agent is disposed within the skeletal structure of the elongated body portion 30, and the bladder 12 for holding another shaving agent is disposed in the hollow space 5 within the bottom portion 32. The razor 50 also comprises side portions 36 and a top and bottom portion 34, separated by a contour 38 (only one side portion and the top portion are shown in FIG. 1A). Alternatively, the razor could have a rounded body portion. FIG. 1B is similar to FIG. 1A, and shows transverse rib portions 40 for further support of the skeletal structure, according to another possible embodiment.

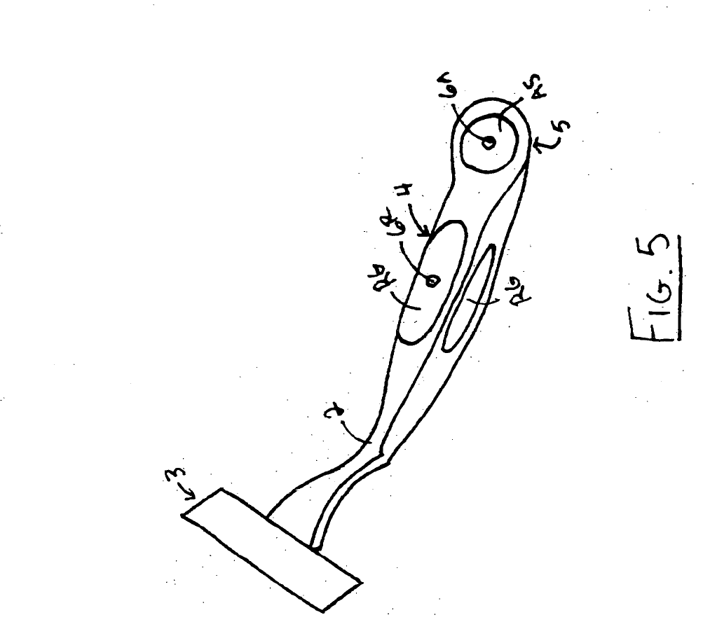

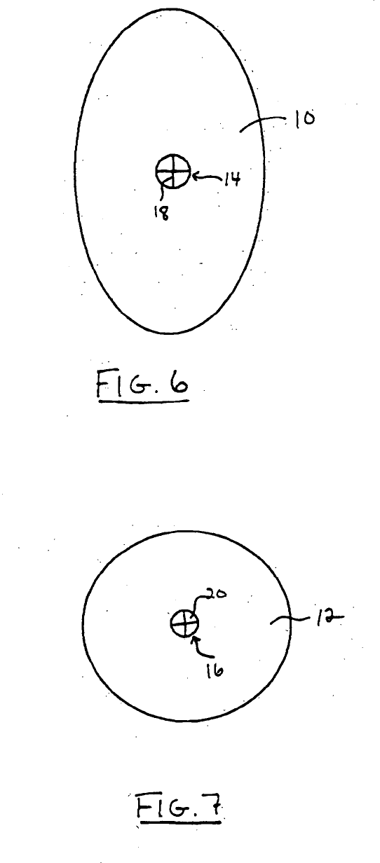

According to another possible embodiment, the razor handle comprises a single injection-moulded handle piece. The single handle piece comprises a hollow space, which hollow space can be separated into two or more parts. According to this possible embodiment, the single handle piece is constructed with a hard plastic material. Flexible bladders 10 and 12 for holding shaving agents, such as shaving gel or shaving cream and aftershave, as shown in FIGS. 6 and 7, are constructed with a flexible, squeezable material such as rubber or a flexible plastic material such as PE, PVC, and PA. The flexible bladders comprise openings 14 and 16 for permitting shaving agent to be squeezed out of the flexible bladder and into the hands of a user. According to one possible embodiment, the openings could comprise valves 18 and 20 that are configured to allow shaving agent to be squeezed out of the bladders only by use of pressure applied by a user, and allow gas or air to enter the bladders once the user has finished squeezing the bladders in order to reform the bladders. The openings 14 and 16 could also be similar to the stay-clean cap with control valve used by the H.J. Heinz Company of Pittsburgh, Pa., for products such as ketchup.

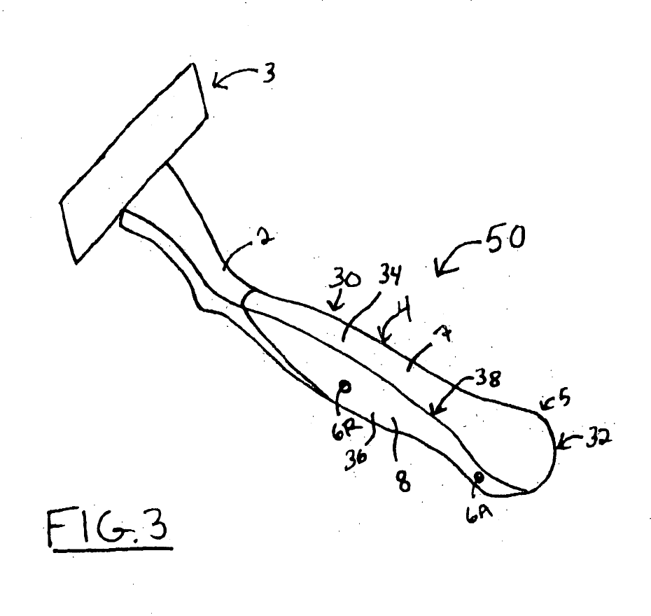

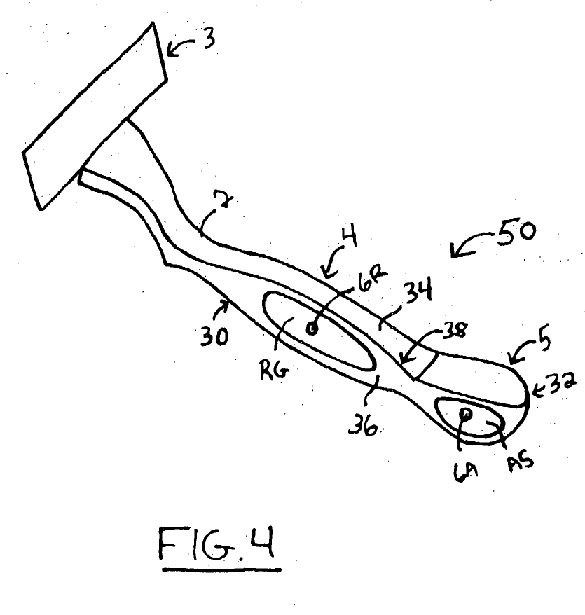

According to this possible embodiment, and as shown in FIGS. 4 and 5, the flexible bladders 10 and 12 are inserted into the hollow spaces in the handle piece. Once the flexible bladders 10 and 12 holding shaving agents such as shaving gel and aftershave have been inserted into the hollow spaces in the handle piece, a user can squeeze shaving agent from the flexible bladder simply by pressing on a section of the bladder RG and AS that is exposed by the hollow spaces. It should be noted that the hollow space may comprise openings on one side of the razor, or it may comprise openings on more than one side of the razor, as shown in FIG. 5.

According to FIGS. 4 and 5, the razor 50 comprises a shaving head 3, a neck portion 2, an elongated body portion 30, and a bottom portion 32. The hollow space 4 for a bladder 10 for holding a shaving agent is disposed within the elongated body portion 30, and the bladder 12 for holding another shaving agent is disposed in the hollow space 5 within the bottom portion 32. The razor 50 also comprises side portions 36 and a top and bottom portion 34, separated by a contour 38 (only one side portion and the top portion are shown in FIGS. 4 and 5). Alternatively, the razor could have a rounded body portion.

It should be noted that since the flexible bladders are removable, they could conceivably be replaced or refilled once all of the shaving agent has been used. The flexible bladders can be sold separately as replacements, and since the head of a razor can be easily removed once the razor blades have been dulled, the razor heads could also be sold separately as replacements. The handle of the razor can therefore be sold separately, or with the flexible bladders installed in the hollow spaces. Similarly, different types of shaving agent could be sold in the flexible bladders, such as shaving gel, shaving cream, aftershave, or variants thereof, such as shaving gel, shaving cream, or aftershave for sensitive skin.

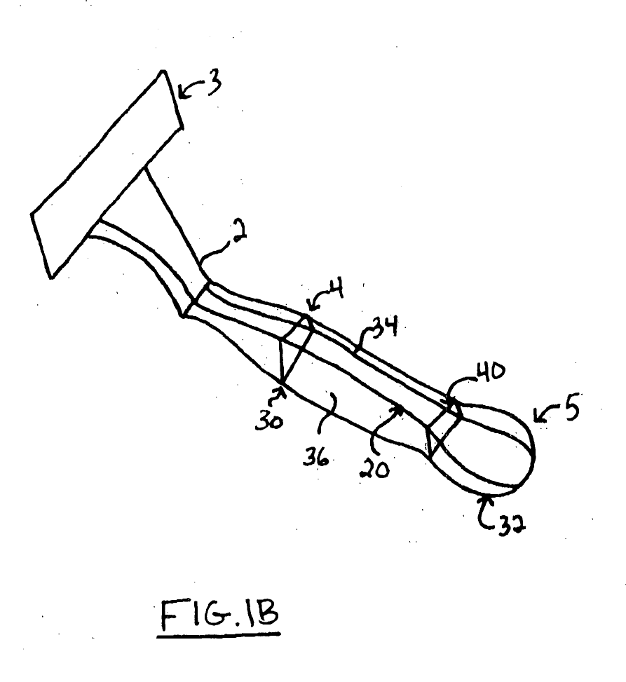

According to another possible embodiment, and as shown in FIG. 3, the razor handle piece is constructed as a skeletal frame. The flexible bladders holding the shaving agents such as shaving gel and aftershave are installed inside the skeletal frame. Once the flexible bladders are installed inside the skeletal frame, a flexible outside skin made of synthetic material is drawn over the skeletal frame. An opening or valve piece that comprises a plastic nozzle is then inserted through the flexible outside skin, whereby it punctures the flexible bladder and is inserted therein.

According to FIG. 3, the razor 50 comprises a shaving head 3, a neck portion 2, an elongated body portion 30, and a bottom portion 32. The hollow space 4 for a bladder 10 for holding a shaving agent is disposed within the elongated body portion 30, and the bladder 12 for holding another shaving agent is disposed in the hollow space 5 within the bottom portion 32. The razor 50 also comprises side portions 36 and a top and bottom portion 34, separated by a contour 38 (only one side portion and the top portion are shown in FIG. 3). Alternatively, the razor could have a rounded body portion.

To squeeze the shaving gel or aftershave from the flexible bladder, a user simply squeezes the flexible outside skin on the side section 8 or the front section 7, where the flexible bladder lies beneath, and thereby squeezes the flexible bladder itself. The shaving gel or aftershave is squeezed through the plastic nozzle and out the opening or valve, into the hand of a user. Since the opening may comprise a valve, the user can shave without the shaving gel or aftershave leaking out the opening. In addition, the razor may be used several times, since the remaining, unused portion of shaving gel or aftershave will remain inside the flexible bladder unless it is squeezed out by the user.

This possible embodiment can be used, for instance, for people on vacation, for business trips, or for other trips that are short in duration. Since the flexible bladders are covered by a flexible outside skin, they can't necessarily be replaced in this possible embodiment. However, the shape of the razor handle piece can be altered so that the flexible bladders can hold extra shaving agent, such as, for example, enough shaving agent to last for a week or more. Once the shaving agent has been exhausted, the user simply throws the razor away, or refills the flexible bladder by squeezing more shaving agent through a plastic nozzle into the opening of the bladder.

It should be noted that FIGS. 3, 4, and 5 show possible embodiments of razors and razor heads 3. The razor heads 3 are only shown for illustrative purposes, and could be any type of razor head. For instance, the razor heads could be round in shape, rectangular in shape, and could have one or more razor blades installed therein. The razor head could also comprise an Aloe strip for users with sensitive skin.

One feature or aspect of an embodiment is believed at the time of the filing of this patent application to possibly reside broadly in a razor consisting of a grip and a shaving appliance attached to the upper end of the grip as well as of a shaving agent container characterized in that the grip in its middle area has at least one hollow compartment for dispensing the shaving agent whereby the walls of the grip in the area of the hollow compartment are at least partially elastically deformable in order to be able to press out the shaving agent.

Another feature or aspect of an embodiment is believed at the time of the filing of this patent application to possibly reside broadly in a razor characterized in that the razor has another hollow compartment for dispensing an after-shave agent whereby the walls of the grip in the area of the hollow compartment are at least partially elastically deformable in order to be able to press out the after-shave agent.

Yet another feature or aspect of an embodiment is believed at the time of the filing of this patent application to possibly reside broadly in a razor characterized in that one compartment or all compartments each have a connection to the surface of the grip by means of a hole.

Still another feature or aspect of an embodiment is believed at the time of the filing of this patent application to possibly reside broadly in a razor characterized in that an actuation surface inside the flexible wall is constructed in a surface structure deviating from the surface of the grip.

A further feature or aspect of an embodiment is believed at the time of the filing of this patent application to possibly reside broadly in a razor characterized in that the structure of the surface stands out in color in addition.

Another feature or aspect of an embodiment is believed at the time of the filing of this patent application to possibly reside broadly in a process for the production of a razor characterized in that the razor is produced from an injection moulded part with disposable cores whereby the hollow compartments in the area of the cores are lined with elastic side walls.

Yet another feature or aspect of an embodiment is believed at the time of the filing of this patent application to possibly reside broadly in a process for the production of a razor characterized in that the razor is produced in skeleton structure whereby a flexible outside skin made of artificial material is pulled over a skeleton previously produced as a moulded plastic part.

A further feature or aspect of an embodiment is believed at the time of the filing of this patent application to possibly reside broadly in a process for the production of a razor characterized in that the skeleton, which forms the grip, is provided with transverse segments which limit the hollow compartments to the top and to the bottom, and characterised in that a shrink film is pulled over the skeleton and is shrunk to a firm compound with the skeleton by means of the action of heat.

Another feature or aspect of an embodiment is believed at the time of the filing of this patent application to possibly reside broadly in a razor for shaving, said razor comprising: a shaving head comprising razor blades being configured to shave hair of a user; a handle portion being configured to be held by a user; said handle portion comprising: a flexible covering being configured and disposed to cover at least part of said body portion; a neck portion being configured to be gripped by a user; a skeletal body portion comprising a plurality of hollow spaces; a plurality of flexible bladders being disposed within said plurality of hollow spaces within said handle portion and being configured to hold shaving agents such as shaving gel and aftershave; said plurality of flexible bladders comprising openings being configured and disposed to permit shaving agents therein to be squeezed out of said plurality of flexible bladders and into the hand of a user; said openings of said plurality of flexible bladders comprising valves being configured to permit shaving agent therein to be squeezed out of said flexible bladder, and being configured to permit air to enter into said flexible bladder upon a user finishing squeezing said flexible bladder; said flexible covering comprising openings and being configured and disposed to be deformable and to permit a user to squeeze said flexible bladders through said flexible covering to permit shaving agent to be squeezed out of said bladder and into the hand of a user.

Yet another feature or aspect of an embodiment is believed at the time of the filing of this patent application to possibly reside broadly in a razor for shaving, said razor comprising: a shaving head comprising razor blades being configured to shave hair of a user; a handle portion being configured to be held by a user; said handle portion comprising: a body portion comprising at least one space; said at least one space being configured to hold shaving agents in said body portion; said at least one space comprising an opening being configured and disposed to permit a shaving agent therein to be squeezed out of said at least one space in said handle portion; said handle comprising a flexible portion being configured and disposed to cover at least a part of said body portion; said flexible portion being configured and disposed to be deformable and to permit a user to squeeze said at least one space through said flexible portion to expel a shaving agent from said at least one space for use by a user.

Still another feature or aspect of an embodiment is believed at the time of the filing of this patent application to possibly reside broadly in a method for the production of a razor, said razor comprising: a shaving head comprising razor blades being configured to shave hair of a user; a handle portion being configured to be held by a user; said handle portion comprising: a body portion comprising at least one space; said at least one space being configured to hold shaving agents in said body portion; said at least one space comprising an opening being configured and disposed to permit a shaving agent therein to be squeezed out of said at least one space in said handle portion; said handle comprising a flexible portion being configured and disposed to cover at least a part of said body portion; said flexible portion being configured and disposed to be deformable and to permit a user to squeeze said at least one space through said flexible portion to expel a shaving agent from said at least one space for use by a user. as set forth in one of the previous claims wherein the razor is produced from an injection moulded part with disposable cores whereby the hollow compartments in the area of the cores are lined with elastic side walls; said method comprising the steps of: said razor is produced in skeleton structure whereby a flexible outside skin made of artificial material is pulled over a skeleton previously produced as a moulded plastic part.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

An example of a method for making a razor, components of which may possibly be utilized or adapted for use in at least one possible embodiment, may possibly be found in U.S. Pat. No. 6,749,788, entitled “Method and apparatus for making a shaving razor handle.”

The appended drawings in their entirety, including all dimensions, proportions and/or shapes in at least one embodiment of the invention, are accurate and are hereby included by reference into this specification.

Some examples of injection molding apparatuses and processes, components of which may possibly be utilized or adapted for use in at least one possible embodiment, may possibly be found in the following U.S. patents: U.S. Pat. No. 6,875,393, entitled “Method and assembly for injection moulding;” U.S. Pat. No. 6,849,219, entitled “Injection moulding methods and apparatus;” U.S. Pat. No. 6,811,730, entitled “Injection moulding process;” U.S. Pat. No. 6,796,782, entitled “Device for injection moulding of plastics;” U.S. Pat. No. 6,733,274, entitled “Injection moulding machine and moulding method;” and U.S. Pat. No. 6,712,597, entitled “Injection-moulding device.”

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

Some examples of razor or shaver heads which may possibly be utilized or adapted for use in at least one possible embodiment may possibly be found in the following U.S. patents: U.S. Pat. No. 6,550,141, entitled “Razor heads with intermediate guard elements;” U.S. Pat. No. 6,418,623, entitled “Dual-blade razor head with adjustable spacer;” U.S. Pat. No. 6,032,372, entitled “Intrinsically fenced safety razor head;” U.S. Pat. No. 5,557,851, entitled “Dynamic flexible razor head;” U.S. Pat. No. 5,546,660, entitled “Dynamic razor head;” U.S. Pat. No. 5,481,802, entitled “Razor head, in particular a razor blade unit of a wet razor;” U.S. Pat. No. 5,447,084, entitled “Razor head of a wet razor;” U.S. Pat. No. 5,412,872, entitled “Razor head with expandable spacer;” U.S. Pat. No. 5,410,812, entitled “Razor head of a wet razor;” U.S. Pat. No. 5,373,638, entitled “Razor head, especially razor blade unit of a wet razor;” U.S. Pat. No. 5,365,665, entitled “Razor head with flow passages;” and U.S. Pat. No. 5,359,774, entitled “Razor head of a wet razor.”

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The corresponding foreign patent publication applications, namely, Federal Republic of Germany Patent Application No. 10 2004 059 517.8, filed on Dec. 10, 2004, having inventors Mahran Wanli and Giuseppe Susino, and DE-OS 10 2004 059 517.8 and DE-PS 10 2004 059 517.8, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

An example of a valve for spill-proof containers, components of which may possibly be utilized or adapted for use in at least one possible embodiment, may possibly be found in U.S. Pat. No. 5,873,478, entitled “Spill-proof cap for beverage containers.”

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A razor for shaving, said razor comprising:
a shaving head comprising razor blades being configured to shave hair of a user;
a handle portion being configured to be held by a user;
said handle portion comprising:
a flexible covering being configured and disposed to cover at least part of said body portion;
a neck portion being configured to be gripped by a user;
a skeletal body portion comprising a plurality of hollow spaces;
a plurality of flexible bladders being disposed within said plurality of hollow spaces within said handle portion and being configured to hold shaving agents such as shaving gel and aftershave;
said plurality of flexible bladders comprising openings being configured and disposed to permit shaving agents therein to be squeezed out of said plurality of flexible bladders and into the hand of a user;
said openings of said plurality of flexible bladders comprising valves being configured to permit shaving agent therein to be squeezed out of said flexible bladder, and being configured to permit air to enter into said flexible bladder upon a user finishing squeezing said flexible bladder;
said flexible covering comprising openings and being configured and disposed to be deformable and to permit a user to squeeze said flexible bladders through said flexible covering to permit shaving agent to be squeezed out of said bladder and into the hand of a user.

2. The razor according to claim 1, wherein said razor comprises a hollow compartment for dispensing an after-shave agent whereby the walls of said flexible covering in the area of said hollow compartment are at least partially elastically deformable in order to be able to press out the after-shave agent.

3. The razor according to claim 2, wherein at least one of said plurality of hollow spaces each have a connection to the surface of said flexible covering by means of a hole.

4. The razor according to claim 3, wherein an actuation surface inside said plurality of bladders is constructed in a surface structure deviating from the surface of said flexible covering.

5. The razor according to claim 4, wherein said skeletal body portion stands out in color from said flexible covering.

6. The razor according to claim 5, wherein at least one of said plurality of hollow spaces each have a connection to the surface of said flexible covering by means of a hole.

7. The razor according to claim 6, wherein an actuation surface inside said plurality of bladders is constructed in a surface structure deviating from the surface of said flexible covering.

8. A razor for shaving, said razor comprising:
a shaving head comprising razor blades being configured to shave hair of a user;
a handle portion being configured to be held by a user;
said handle portion comprising:
a body portion comprising at least one space;
said at least one space being configured to hold shaving agents in said body portion;
said at least one space comprising an opening being configured and disposed to permit a shaving agent therein to be squeezed out of said at least one space in said handle portion;
said handle comprising a flexible portion being configured and disposed to cover at least a part of said body portion;
said flexible portion being configured and disposed to be deformable and to permit a user to squeeze said at least one space through said flexible portion to expel a shaving agent from said at least one space for use by a user.

9. The razor according to claim 8, wherein said razor comprises a hollow compartment for dispensing an after-shave agent whereby the walls of said flexible portion in the area of said hollow compartment are at least partially elastically deformable in order to be able to press out the after-shave agent.

10. The razor according to claim 9, wherein at least one of said at least one space has a connection to the surface of said flexible portion by means of a hole.

11. The razor according to claim 10, wherein an actuation surface inside said at least one space is constructed in a surface structure deviating from the surface of said flexible portion.

12. The razor according to claim 11, wherein said body portion stands out in color from said flexible portion.

13. The razor according to claim 12, wherein at least one of said at least one space has a connection to the surface of said flexible portion by means of a hole.

14. The razor according to claim 13, wherein an actuation surface inside said at least one space is constructed in a surface structure deviating from the surface of said flexible portion.

15. Method for the production of a razor, said razor comprising: a shaving head comprising razor blades being configured to shave hair of a user; a handle portion being configured to be held by a user; said handle portion comprising: a body portion comprising at least one space; said at least one space being configured to hold shaving agents in said body portion; said at least one space comprising an opening being configured and disposed to permit a shaving agent therein to be squeezed out of said at least one space in said handle portion; said handle comprising a flexible portion being configured and disposed to cover at least a part of said body portion; said flexible portion being configured and disposed to be deformable and to permit a user to squeeze said at least one space through said flexible portion to expel a shaving agent from said at least one space for use by a user. as set forth in one of the previous claims wherein the razor is produced from an injection moulded part with disposable cores whereby the hollow compartments in the area of the cores are lined with elastic side walls; said method comprising the steps of:
said razor is produced in skeleton structure whereby a flexible outside skin made of artificial material is pulled over a skeleton previously produced as a moulded plastic part.

16. The method according to claim 15, wherein said body portion, which forms a grip, comprises transverse segments which limit said at least one space to the top and to the bottom, and wherein a shrink film is pulled over said body portion and is shrunk to a firm compound with said body portion by means of the action of heat.

17. The method according to claim 16, wherein said razor comprises a hollow compartment for dispensing an after-shave agent whereby the walls of said flexible portion in the area of said hollow compartment are at least partially elastically deformable in order to be able to press out the after-shave agent.

18. The razor according to claim 17, wherein at least one of said at least one space has a connection to the surface of said flexible portion by means of a hole.

19. The method according to claim 18, wherein an actuation surface inside said at least one space is constructed in a surface structure deviating from the surface of said flexible portion.

20. The razor according to claim 19, wherein said body portion stands out in color from said flexible portion.
